(19) United States
(12) Patent Application Publication
(10) Pub. No.: US 2024/0080932 A1
(43) Pub. Date: Mar. 7, 2024

(54) METHOD AND DEVICE IN NODES USED FOR WIRELESS COMMUNICATION

(71) Applicant: Lu WU, Shanghai (CN)

(72) Inventor: Lu WU, Shanghai (CN)

(73) Assignee: SHANGHAI TUILUO COMMUNICATION TECHNOLOGY PARTNERSHIP (LIMITED PARTNERSHIP), Shanghai, OT (CN)

(21) Appl. No.: 18/507,121

(22) Filed: Nov. 13, 2023

Related U.S. Application Data
(63) Continuation of application No. PCT/CN2022/091601, filed on May 9, 2022.

(30) Foreign Application Priority Data
May 14, 2021 (CN) 202110525860.7

(51) Int. Cl. H04W 76/20; H04B 7/06; H04W 72/232

(52) U.S. Cl. CPC H04W 76/20; H04B 7/06968; H04W 72/232

(57) ABSTRACT

A first node receives a first information block; receives a first signaling; and receives a first signal. The first information block is used for indicating S search space sets; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set.

### CROSS REFERENCE TO RELATED APPLICATIONS

This application is the continuation of the International Patent application No. PCT/CN2022/091601, filed on May 9,2022, and claims the priority benefit of Chinese Patent Application No. 202110525860.7, filed on May 14, 2021, the full disclosure of which is incorporated herein by reference.

### BACKGROUND

### Technical Field

The present application relates to transmission methods and devices in wireless communication systems, and in particular to a scheme and device for control signaling designing in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

The multi-antenna (e.g., Multiple Input Multiple Output, abbreviated as MIMO, multi-Transmission Reception Point (multi-TRP), and multi-panel) techniques make up an integral part in the New Radio (NR) techniques. To adapt to more diversified application scenarios and meet higher requirements, a Work Item (WI) on further enhancement of MIMO under NR was approved at the 3GPP RAN #86 plenary to provide support for multi-antenna communications which is more robust, with higher spectral efficiency and more application scenarios.

### SUMMARY

In a multi-antenna system, like the Multi-Transmission Reception Point (Multi-TRP)/Multi-Panel communications, the robustness of transmission can be enhanced in a way that a same channel or signal is transmitted through multiple transmission reception points. The Multi-TRP/Multi-panel transmission of a data channel is supported in Rel-16, and the 3GPP planned to introduce the Multi-TRP/Multi-panel transmission of a control channel in Rel-17.

To address the issue of control channel in a multi-antenna system, the present application provides a solution. It should be noted that the statement in the present application only takes the multi-antenna system, especially a multi-TRP/multi-panel transmission system, as a typical application scenario or example; This disclosure is also applicable to other scenarios confronting similar problems, such as scenarios having higher demands on the robustness or coverage of control channels, or in need of PDCCH-linked scenario apart from multi-TRP/multi-panel transmissions, which include but are not limited to coverage enhancement system, the Internet of Things (IoT), Ultra Reliable Low Latency Communications (URLLC) network and Vehicle-to-Everything (V2X), where similar technical effects can be achieved. Additionally, the adoption of a unified solution for various scenarios, including but not limited to multi-antenna systems, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:

receiving a first information block; receiving a first signaling; and receiving a first signal;

herein, the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one embodiment, a problem to be solved in the present application is: how to determine a range of values of a TCI state indicated by a control channel in a multi-antenna system.

In one embodiment, a problem to be solved in the present application is: how to determine a TCI state of a data channel scheduled by a control channel with both single-TRP and multi-TRP being supported.

In one embodiment, the essence of the above method lies in that a first signaling is a control signaling, and a first signal is a data channel transmission scheduled by the first signaling; the multi-TRP case is applicable when a first condition set is satisfied, while the single-TRP case is applicable when the first condition set is not satisfied; a range of values of a TCI state of a data channel is determined depending on whether it is the single -TRP case or the multi-TRP case that applies. The method above is advantageous in that both single-TRP and multi-TRP cases are supported, so that a more appropriate TCI state can be used based on different situations, which enhances the reliability and transmission efficiency of the system.

According to one aspect of the present application, the above method is characterized in that when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

According to one aspect of the present application, the above method is characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set.

According to one aspect of the present application, the above method is characterized in comprising:

receiving a second information block, receiving a third information block and receiving a fourth information block;

herein, the second information block indicates the first TCI state set, the third information block indicates the second TCI state set, while the fourth information block indicates the third TCI state set; each of the second information block, the third information block and the fourth information block comprises a second field, the second field indicating a bandwidth part (BWP), where the second field in the second information block, the second field in the third information block and the second field in the fourth information block all indicate a first bandwidth part (BWP); each of the S search space sets belongs to the first bandwidth part (BWP); among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

According to one aspect of the present application, the above method is characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

According to one aspect of the present application, the above method is characterized in that the phrase that “one control channel candidate associated with the first control channel candidate” includes a meaning that the first node assumes that a Downlink Control Information (DCI) in the control channel candidate is identical to a DCI in the first control channel candidate.

According to one aspect of the present application, the above method is characterized in that the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

According to one aspect of the present application, the above method is characterized in comprising:

transmitting a target information block;

herein, the target information block is used to indicate whether the first signal is correctly received.

The present application provides a method in a second node for wireless communications, comprising:

transmitting a first information block; transmitting a first signaling; transmitting a first signal;

herein, the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

According to one aspect of the present application, the above method is characterized in that when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

According to one aspect of the present application, the above method is characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set.

According to one aspect of the present application, the above method is characterized in comprising:

transmitting a second information block, transmitting a third information block and transmitting a fourth information block;

herein, the second information block indicates the first TCI state set, the third information block indicates the second TCI state set, while the fourth information block indicates the third TCI state set; each of the second information block, the third information block and the fourth information block comprises a second field, the second field indicating a bandwidth part (BWP), where the second field in the second information block, the second field in the third information block and the second field in the fourth information block all indicate a first bandwidth part (BWP); each of the S search space sets belongs to the first bandwidth part (BWP); among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

According to one aspect of the present application, the above method is characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

According to one aspect of the present application, the above method is characterized in that the phrase that “one control channel candidate associated with the first control channel candidate” includes a meaning that a receiver of the first signaling assumes that a Downlink Control Information (DCI) in the control channel candidate is identical to a DCI in the first control channel candidate.

According to one aspect of the present application, the above method is characterized in that the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

According to one aspect of the present application, the above method is characterized in comprising:

receiving a target information block;

herein, the target information block is used to indicate whether the first signal is correctly received.

The present application provides a first node for wireless communications, comprising:

a first receiver, receiving a first information block; receiving a first signaling; and receiving a first signal;

herein, the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

The present application provides a second node for wireless communications, comprising:

a second transmitter, transmitting a first information block; transmitting a first signaling; transmitting a first signal;

herein, the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one embodiment, the method in the present application has the following advantages: with the method provided in the present application, both single-TRP and multi-TRP cases are supported, so that a more appropriate TCI state can be used based on different situations, which enhances the reliability and transmission efficiency of the system.

### BRIEF DESCRIPTION OF THE DRAWINGS

Other features, objects and advantages of the present application will become more apparent from the

detailed description of non-restrictive embodiments taken in conjunction with the following drawings:

FIG. 1 illustrates a flowchart of a first information block, a first signaling and a first signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a target TCI state set according to one embodiment of the present application.

FIG. 7 illustrates a schematic diagram of a target TCI state set according to another embodiment of the present application.

FIG. 8 illustrates a schematic diagram of a second information block, a third information block and a fourth information block according to one embodiment of the present application.

FIG. 9 illustrates a schematic diagram illustrating a control channel candidate associated with the first control channel candidate according to one embodiment of the present application.

FIG. 10 illustrates a schematic diagram illustrating a control channel candidate associated with the first control channel candidate according to another embodiment of the present application.

FIG. 11 illustrates a schematic diagram illustrating a control channel candidate associated with the first control channel candidate according to another embodiment of the present application.

FIG. 12 illustrates a structure block diagram of a processing device in a first node according to one embodiment of the present application.

FIG. 13 illustrates a structure block diagram a processing device in a second node according to one embodiment of the present application.

### DESCRIPTION OF THE EMBODIMENTS

The technical scheme of the present application is described below in further details in conjunction with

the drawings. It should be noted that the embodiments of the present application and the characteristics of the embodiments may be arbitrarily combined if no conflict is caused.

### Embodiment 1

Embodiment 1 illustrates a flowchart of a first information block, a first signaling and a first signal according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first information block in step 101; and receives a first signaling in step 102; and receives a first signal in step 103; herein, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one embodiment, the first information block is borne by a higher layer signaling

In one embodiment, the higher layer signaling includes a Radio Resource Control (RRC) signaling

In one embodiment, the higher layer signaling includes a MAC CE signaling

In one embodiment, the first information block comprises one Information Element (IE) in an RRC signaling

In one embodiment, the first information block comprises multiple IEs in an RRC signaling

In one embodiment, the first information block comprises part of fields in an IE in an RRC signaling

In one embodiment, the first information block comprises part of or all fields in an IE PDCCH-Config.

In one embodiment, the first information block comprises a field searchSpacesToAddModList in an IE PDCCH-Config.

In one embodiment, the first information block comprises an IE SearchSpace.

In one embodiment, a first information block explicitly indicates S search space sets.

In one embodiment, a first information block implicitly indicates S search space sets.

In one embodiment, a first information block indicates at least one of search space set indexes, associated CORESETs, control channel monitoring periodicities and offsets, numbers of control channel candidates of each CCE Aggregation Level or search space types that respectively correspond to the S search space sets.

In one embodiment, the first information block comprises S information sub-blocks, the S information sub-blocks being respectively used for indicating S search space sets.

In one subembodiment, the S information sub-blocks respectively indicate at least one of search space set indexes, associated CORESETs, control channel monitoring periodicities and offsets, numbers of control channel candidates of each CCE Aggregation Level or search space types that respectively correspond to the S search space sets.

In one embodiment, any information sub-block among the S information sub-blocks comprises an IE SearchSpace.

In one embodiment, S is no greater than 10.

In one embodiment, the S search space sets belong to a same BandWidth Part (BWP).

In one embodiment, the S search space sets belong to a same Carrier.

In one embodiment, the S search space sets belong to a same Serving Cell.

In one embodiment, the phrase that “the S search space sets belong to a same BandWidth Part (BWP)” includes a meaning that: the S search space sets belong to a same BWP in frequency domain.

In one embodiment, the phrase that “the S search space sets belong to a same BandWidth Part (BWP)” includes a meaning that: the S search space sets are configured for a same BWP.

In one embodiment, the first signal is a Physical Downlink Shared Channel (PDSCH).

In one embodiment, the first signal is transmitted on a PDSCH.

In one embodiment, the first signal carries a target bit block, the target bit block comprising a positive integer number of bit(s).

In one embodiment, the first signal comprises at least one sub-signal, of which a sub-signal comprises a transmission of a target bit block.

In one embodiment, the first signal comprises only one transmission of a target bit block.

In one embodiment, the first signal comprises S sub-signals, each of the S sub-signals carrying a target bit block, S being a positive integer greater than 1.

In one embodiment, the first signal comprises S sub-signals, the S sub-signals respectively comprising S Repetitions of a target bit block.

In one embodiment, when the first field in the first signaling only indicates one TCI state, any sub-signal in the first signal uses the TCI state indicated by the first field in the first signaling

In one embodiment, when the first field in the first signaling indicates two TCI states, at least two sub-signals in the first signal respectively use the two TCI states indicated by the first field in the first signaling

In one embodiment, the target bit block comprises a positive integer number of Transport Block(s) (TB(s)).

In one embodiment, the target bit block comprises one TB.

In one embodiment, the target bit block comprises at least one Code Block Group (CBG).

In one embodiment, the first signal is obtained by the target bit block sequentially through CRC Insertion, Channel Coding, Rate Matching, Scrambling, Modulation, Layer Mapping, Precoding, Mapping to Resource Element, OFDM Baseband Signal Generation, and Modulation and Upconversion.

In one embodiment, the first signal is obtained by the target bit block sequentially through CRC Insertion, Channel Coding, Rate Matching, Scrambling, Modulation, Layer Mapping, Precoding, Mapping to Virtual Resource Blocks, Mapping from Virtual to Physical Resource Blocks, OFDM Baseband Signal Generation, and Modulation and Upconversion.

In one embodiment, the first signal is obtained by the target bit block sequentially through CRC Insertion, Segmentation, Code Block (CB)-level CRC Insertion, Channel Coding, Rate Matching, Concatenation, Scrambling, Modulation, Layer Mapping, Precoding, Mapping to Resource Element, OFDM Baseband Signal Generation, and Modulation and Upconversion.

In one embodiment, a said sub-signal in the first signal is obtained by the target bit block sequentially through CRC Insertion, Channel Coding, Rate Matching, Scrambling, Modulation, Layer Mapping, Precoding, Mapping to Resource Element, OFDM Baseband Signal Generation, and Modulation and Upconversion.

In one embodiment, a said sub-signal in the first signal is obtained by the target bit block sequentially through CRC Insertion, Channel Coding, Rate Matching, Scrambling, Modulation, Layer Mapping, Precoding, Mapping to Virtual Resource Blocks, Mapping from Virtual to Physical Resource Blocks, OFDM Baseband Signal Generation, and Modulation and Upconversion.

In one embodiment, a said sub-signal in the first signal is obtained by the target bit block sequentially through CRC Insertion, Segmentation, Code Block (CB)-level CRC Insertion, Channel Coding, Rate Matching, Concatenation, Scrambling, Modulation, Layer Mapping, Precoding, Mapping to Resource Element, OFDM Baseband Signal Generation, and Modulation and Upconversion.

In one embodiment, the first signaling is a physical layer signaling

In one embodiment, the first signaling is dynamically configured.

In one embodiment, the first signaling is a Downlink Control Information (DCI) signaling

In one embodiment, the first signaling is transmitted on a Physical Downlink Control Channel (PDCCH).

In one embodiment, the first signaling schedules reception of a Physical Downlink Shared Channel (PDSCH).

In one embodiment, a higher layer parameter configures that the first signaling comprises the first field.

In one embodiment, a higher layer parameter tci-PresentInDCI configures that the first signaling comprises the first field

In one embodiment, the first field is a Transmission configuration indication field.

In one embodiment, the specific definition of the Transmission configuration indication field can be found

in 3GPP TS38.212, section 7.3.

In one embodiment, the specific definition of the higher layer parameter tci-PresentInDCI can be found in 3GPP TS38.212, section 7.3.

In one embodiment, the first field comprises 3 bits.

In one embodiment, the first field comprises one bit.

In one embodiment, the first field comprises more than one bit.

In one embodiment, a number of bit(s) comprised by the first field is pre-defined.

In one embodiment, a number of bit(s) comprised by the first field is configured by a higher layer parameter.

In one embodiment, the sentence that “the first field in the first signaling indicating a Transmission Configuration Indicator (TCI) state of the first signal in a target TCI state set” includes a meaning that: the first node determines the TCI state of the first signal uniquely in the target TCI state set according to the value of the first field in the first signaling

In one embodiment, the sentence that “the first field in the first signaling indicating a TCI state of the first signal in a target TCI state set” includes a meaning that: the first field in the first signaling indicates an index of the TCI state of the first signal in the target TCI state set.

In one embodiment, the sentence that “the first field in the first signaling indicating a TCI state of the first signal in a target TCI state set” includes a meaning that: the value of the first field in the first signaling indicates an index of the TCI state of the first signal in the target TCI state set.

In one embodiment, the sentence that “the first field in the first signaling indicating a TCI state of the first signal in a target TCI state set” includes a meaning that: a value range of the first field comprises N candidate values, and any TCI state in the target TCI state set corresponds to one of the N candidate values, where the TCI state of the first signal is a TCI state in the target TCI state set that corresponds to the value of the first field in the first signaling; any of the N candidate values is a non-negative integer.

In one embodiment, the sentence that “the first field in the first signaling indicating a TCI state of the first signal in a target TCI state set” includes a meaning that: a value range of the first field comprises N candidate values, and the target TCI state set comprises N1 TCI state subsets, and any TCI state subset of the N1 TCI state subsets corresponds to one of the N candidate values, where the TCI state of the first signal belongs to a TCI state subset among the N1 TCI state subsets that corresponds to the value of the first field in the first signaling; any of the N1 TCI state subsets comprises at least one TCI state, N being a positive integer greater than 1 and N1 being a positive integer greater than 1 but no greater than N; any of the N candidate values is a non-negative integer.

In one embodiment, the target TCI state set comprises more than one TCI state.

In one embodiment, the TCI state of the first signal is a TCI state in the target TCI state set.

In one embodiment, the target TCI state set comprises N1 TCI state subsets, where the TCI state of the first signal belongs to a TCI state subset among the N1 TCI state subsets; N1 is a positive integer greater than 1.

In one embodiment, the first control channel candidate is a Physical Downlink Control Channel (PDCCH) Candidate.

In one embodiment, the first control channel candidate is a monitored Physical Downlink Control Channel Candidate (Monitored PDCCH Candidate).

In one embodiment, the first control channel candidate occupies multiple Resource Elements (REs).

In one embodiment, the first control channel candidate occupies one or more Control Channel Elements (CCEs).

In one embodiment, a number of CCE(s) occupied by the first control channel candidate is equal to one of 1, 2, 4, 8 or 16.

In one embodiment, a CCE comprises 9 Resource Element Groups (REGs), of which one REG comprises 4 REs.

In one embodiment, a CCE comprises 6 REGs, of which one REG comprises 12 REs.

In one embodiment, the first Search Space Set comprises at least one control channel candidate.

In one embodiment, the first Search Space Set comprises multiple REs.

In one embodiment, the specific definition of the Search Space Set can be found in 3GPP TS 38.213, Section 10.

In one embodiment, the specific definition of the PDCCH candidate can be found in 3GPP TS 38.213, Section 10.

In one embodiment, time-frequency resources occupied by the first signaling comprise all REs occupied by the first control channel candidate.

In one embodiment, time-frequency resources occupied by the first signaling consist of all REs occupied by the first control channel candidate.

In one embodiment, the sentence that “whether the first condition set is satisfied is used to determine the target TCI state set” includes a meaning that: whether the first condition set is satisfied is used to determine which one of M TCI state sets is the target TCI state set, M being a positive integer greater than 1.

In one embodiment, the sentence that “whether the first condition set is satisfied is used to determine the target TCI state set” includes a meaning that: whether the first condition set is satisfied is used to determine whether the target TCI state set is a third TCI state set.

In one embodiment, the sentence that “whether the first condition set is satisfied is used to determine the target TCI state set” includes a meaning that: whether the first condition set is satisfied is used to determine which one of a first TCI state set, a second TCI state set or a third TCI state set is the target TCI state set.

In one embodiment, the sentence that “whether the first condition set is satisfied is used to determine which one of M TCI state sets is the target TCI state set, M being a positive integer greater than 1” includes a meaning that: when the first condition set is not satisfied, the target TCI state set is a TCI state set with an index that is not the smallest among M TCI state sets; when the first condition set is satisfied, the target TCI state set is a TCI state set with a smallest index among M TCI state sets.

In one embodiment, the sentence that “whether the first condition set is satisfied is used to determine which one of M TCI state sets is the target TCI state set, M being a positive integer greater than 1” includes a meaning that: when the first condition set is not satisfied, the target TCI state set is a TCI state set with a smallest index among M TCI state sets; when the first condition set is satisfied, the target TCI state set is a TCI state set with an index that is not the smallest among M TCI state sets.

In one embodiment, the sentence that “whether the first condition set is satisfied is used to determine whether the target TCI state set is a third TCI state set” includes a meaning that: when the first condition set is not satisfied, the target TCI state set is not a third TCI state set; when the first condition set is satisfied, the target TCI state set is a third TCI state set.

In one embodiment, whether the first condition set is satisfied is used to determine whether there is a TCI state subset in the target TCI state set that comprises more than one TCI state.

In one embodiment, when the first condition set is satisfied, at least one TCI state subset in the target TCI state set comprises more than one TCI state.

In one embodiment, when the first condition set is satisfied, any TCI state subset in the target TCI state set comprises more than one TCI state.

In one embodiment, when the first condition set is unsatisfied, at least one TCI state subset in the target TCI state set comprises only one TCI state.

In one embodiment, when the first condition set is unsatisfied, any TCI state subset in the target TCI state set comprises only one TCI state.

In one embodiment, when there exists a search space set other than the first search space set among the S search space sets that comprises one control channel candidate associated with the first control channel candidate, the first condition set is satisfied.

In one embodiment, that “there exists a search space set other than the first search space set among the S search space sets that comprises one control channel candidate associated with the first control channel candidate” is a necessary condition for a first condition set being satisfied.

In one embodiment, that “there exists a search space set other than the first search space set among the S search space sets that comprises one control channel candidate associated with the first control channel candidate” is a sufficient and necessary condition for a first condition set being satisfied.

In one embodiment, that “there exists a search space set other than the first search space set among the S search space sets that comprises one control channel candidate associated with the first control channel candidate” is a necessary but not sufficient condition for a first condition set being satisfied.

In one embodiment, when any control channel candidate in any search space set other than the first search space set among the S search space sets is not associated with the first control channel candidate, the first condition set is not satisfied.

In one embodiment, when any control channel candidate other than the first control channel candidate in the S search space sets is not associated with the first control channel candidate, the first condition set is not satisfied.

In one embodiment, a first condition comprises that there exists a search space set other than the first search space set among the S search space sets that comprises one control channel candidate associated with the first control channel candidate; a first condition set comprises the first condition.

In one subembodiment, the first condition set only comprises the first condition.

In one subembodiment, the first condition set comprises more than one condition, with the first condition being one of the more than one condition.

In one subembodiment, the first condition set comprises more than one condition, with the first condition being one of the more than one condition; when there is one condition in the first condition set being satisfied, the first condition set is satisfied; when none of conditions in the first condition set is satisfied, the first condition set is not satisfied.

In one subembodiment, the first condition set comprises more than one condition, with the first condition being one of the more than one condition; when each of conditions in the first condition set is satisfied, the first condition set is satisfied; when there is one condition in the first condition set not being satisfied, the first condition set is unsatisfied.

### Embodiment 2

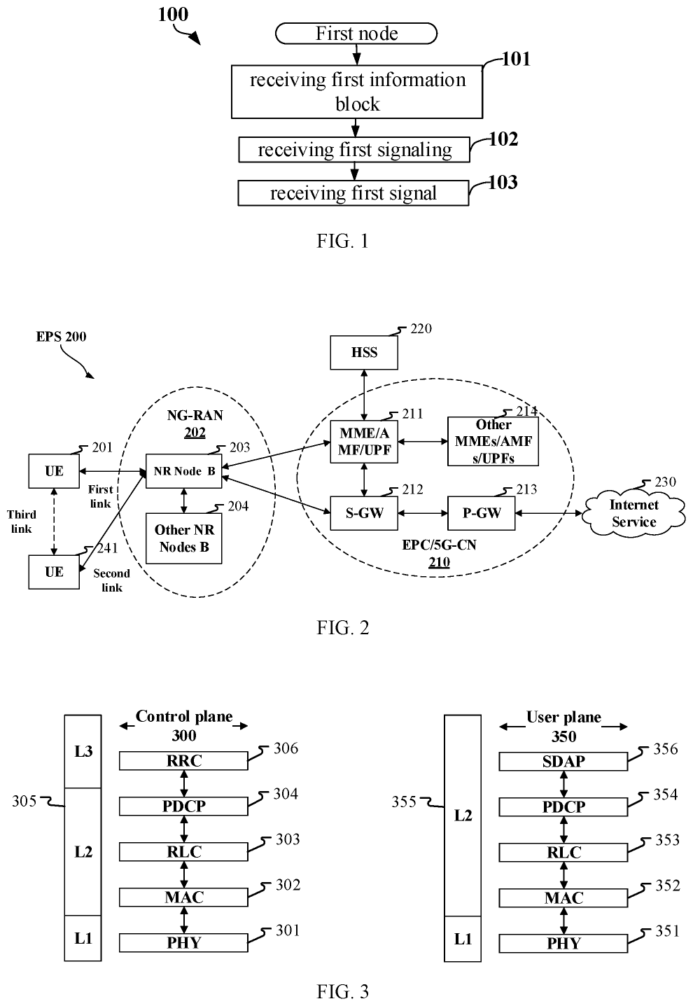

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called abase station, abase transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/ Authentication Management Field (AMF)/ User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 241 corresponds to the second node in the present application.

In one embodiment, the gNB 203 corresponds to the second node in the present application.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC sublayer 306.

In one embodiment, the first information block in the present application is generated by the RRC sublayer 306.

In one embodiment, the first information block in the present application is generated by the MAC sublayer 302.

In one embodiment, the first information block in the present application is generated by the MAC sublayer 352.

In one embodiment, the first information block in the present application is generated by the PHY 301.

In one embodiment, the first information block in the present application is generated by the PHY 351.

### Embodiment 4

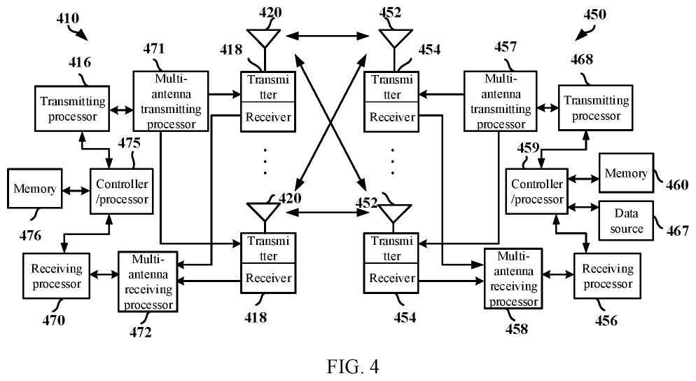

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475.

The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the LI layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a first information block; receives a first signaling; and receives a first signal; herein, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one subembodiment, the second communication device 450 corresponds to the first node in the present application.

In one embodiment, the second communication device 450 comprises a memory that stores a computer readable instruction program, the computer readable instruction program generates actions when executed by at least one processor, which include: receiving a first information block; receiving a first signaling; and receiving a first signal; herein, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one subembodiment, the second communication device 450 corresponds to the first node in the present application.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a first information block; transmits a first signaling; transmits a first signal; herein, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one subembodiment, the first communication device 410 corresponds to the second node in the present application.

In one embodiment, the first communication device 410 comprises a memory that stores a computer readable instruction program, the computer readable instruction program generates actions when executed by at least one processor, which include: transmitting a first information block; transmitting a first signaling; transmitting a first signal; herein, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460 or the data source 467 is used for receiving the first information block in the present application; at least one of the antenna 420, the transmitter 418, the multi-antenna transmitting processor 471, the transmitting processor 416, the controller/processor 475 or the memory 476 is used for transmitting the first information block in the present application.

In one embodiment, at least one of the antenna 452, the receiver 454, the multi-antenna receiving processor 458, the receiving processor 456, the controller/processor 459, the memory 460 or the data source 467 is used for receiving the second information block in the present application; at least one of the antenna 420, the transmitter 418, the multi-antenna transmitting processor 471, the transmitting processor 416, the controller/processor 475 or the memory 476 is used for transmitting the second information block in the present application.

In one embodiment, at least one of the antenna 452, the receiver 454, the multi-antenna receiving processor 458, the receiving processor 456, the controller/processor 459, the memory 460 or the data source 467 is used for receiving the third information block in the present application; at least one of the antenna 420, the transmitter 418, the multi-antenna transmitting processor 471, the transmitting processor 416, the controller/processor 475 or the memory 476 is used for transmitting the third information block in the present application.

In one embodiment, at least one of the antenna 452, the receiver 454, the multi-antenna receiving processor 458, the receiving processor 456, the controller/processor 459, the memory 460 or the data source 467 is used for receiving the fourth information block in the present application; at least one of the antenna 420, the transmitter 418, the multi-antenna transmitting processor 471, the transmitting processor 416, the controller/processor 475 or the memory 476 is used for transmitting the fourth information block in the present application.

In one embodiment, at least one of the antenna 452, the receiver 454, the multi-antenna receiving processor 458, the receiving processor 456, the controller/processor 459, the memory 460 or the data source 467 is used for receiving the first signaling in the present application; at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the receiver 454, the multi-antenna receiving processor 458, the receiving processor 456, the controller/processor 459, the memory 460 or the data source 467 is used for receiving the first signal in the present application; at least one of the antenna 420, the transmitter 418, the multi-antenna transmitting processor 471, the transmitting processor 416, the controller/processor 475 or the memory 476 is used for transmitting the first signal in the present application.

In one embodiment, at least one of the antenna 452, the transmitter 454, the multi-antenna transmitting processor 458, the transmitting processor 468, the controller/processor 459, the memory 460 or the data source 467 is used for transmitting the target information block in the present application; at least one of the antenna 420, the receiver 418, the multi-antenna receiving processor 472, the receiving processor 470, the controller/processor 475 or the memory 476 is used for receiving the target information block in the present application.

### Embodiment 5

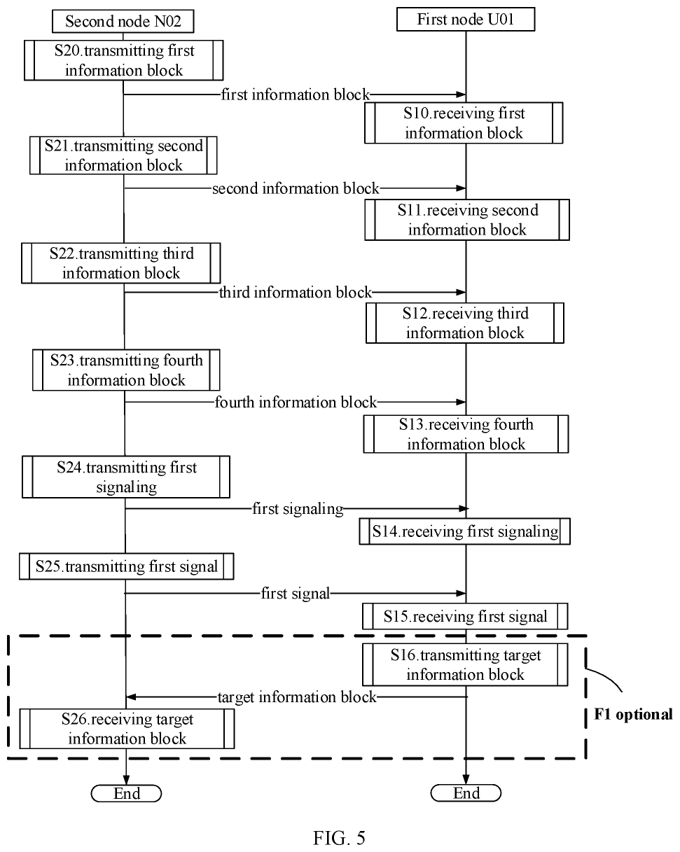

Embodiment 5 illustrates a flowchart of radio signal transmission according to one embodiment of the present application, as shown in FIG. 5. In FIG. 5 a first node U01 and a second node N02 are in communications via an air interface. In FIG. 5, the dotted-line box F1 is optional.

The first node U01 receives a first information block in step S10; receives a second information block in step S11; receives a third information block in step S12; receives a fourth information block in step S13; and receives a first signaling in step S14; receives a first signal in step S15; and transmits a target information block in step S16.

The second node N02 transmits a first information block in step S20; transmits a second information block in step S21; transmits a third information block in step S22; transmits a fourth information block in step S23; and transmits a first signaling in step S24; transmits a first signal in step S25; and receives a target information block in step S26.

In Embodiment 5, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit. the second information block indicates the first TCI state set, the third information block indicates the second TCI state set, while the fourth information block indicates the third TCI state set; each of the second information block, the third information block and the fourth information block comprises a second field, the second field indicating a bandwidth part (BWP), where the second field in the second information block, the second field in the third information block and the second field in the fourth information block all indicate a first bandwidth part (BWP); each of the S search space sets belongs to the first bandwidth part (BWP); among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

In one embodiment, transmission of the first information block is earlier than transmission of the second information block, the third information block and the fourth information block.

In one embodiment, transmission of the first information block is later than transmission of the second information block, the third information block and the fourth information block.

In one embodiment, transmission of the first information block is earlier than transmission of one information block of the second information block, the third information block or the fourth information block.

In one embodiment, transmission of the first information block is later than transmission of one information block of the second information block, the third information block or the fourth information block.

In one embodiment, transmission of the first information block is earlier than transmission of one information block of the second information block, the third information block or the fourth information block, and the transmission of the first information block is later than transmission of the other one information block of the second information block, the third information block or the fourth information block.

In one embodiment, the target information block comprises HARQ-ACK information for the first signal.

In one embodiment, the first signaling indicates time-frequency resources occupied by the target information block.

In one embodiment, the control channel candidate is any control channel candidate in any search space set among the S search space sets other than the first search space set.

In one embodiment, the control channel candidate is the second control channel candidate.

In one embodiment, the phrase that “one control channel candidate associated with the first control channel candidate” includes a meaning that a search space set to which the control channel candidate belongs is of a same type as the first search space set.

In one embodiment, a type of a search space set is UE-specific search space (USS) or Common search space (CSS).

In one embodiment, the phrase that “one control channel candidate associated with the first control channel candidate” includes a meaning that a search space set to which the control channel candidate belongs is of a same DCI format as the first search space set.

In one embodiment, the phrase that “one control channel candidate associated with the first control channel candidate” includes a meaning that the control channel candidate and the first control channel candidate are of a same aggregation level (AL).

In one embodiment, the phrase that “one control channel candidate associated with the first control channel candidate” includes a meaning that for each AL, a number of control channel candidate(s) comprised by the search space set to which the control channel candidate belongs is identical to a number of control channel candidate(s) comprised by the first search space set.

In one embodiment, the phrase that “one control channel candidate associated with the first control channel candidate” includes a meaning that the control channel candidate and the first control channel candidate have a same candidate index.

In one embodiment, the phrase that “one control channel candidate associated with the first control channel candidate” includes a meaning that the control channel candidate and the first control channel candidate have identical scrambling.

In one embodiment, the sentence that “the control channel candidate and the first control channel candidate have identical scrambling” comprises the following meaning: a first scrambling sequence is a scrambling sequence of a PDCCH carried by the first control channel candidate, while a second scrambling sequence is a scrambling sequence of a PDCCH carried by the control channel candidate, the first scrambling sequence and the second scrambling sequence being the same.

In one embodiment, the sentence that “the control channel candidate and the first control channel candidate have identical scrambling” comprises the following meaning: a first scrambling sequence is a scrambling sequence of a PDCCH carried by the first control channel candidate, while a second scrambling sequence is a scrambling sequence of a PDCCH carried by the control channel candidate, where elements in the first scrambling sequence and elements in the second scrambling sequence are the same in one-to-one correspondence.

In one embodiment, the sentence that “the control channel candidate and the first control channel candidate have identical scrambling” comprises the following meaning: a first scrambling sequence is a scrambling sequence of a PDCCH carried by the first control channel candidate, while a second scrambling sequence is a scrambling sequence of a PDCCH carried by the control channel candidate, where an initial value of a Generator for the first scrambling sequence and an initial value of a Generator for the second scrambling sequence are the same.

In one embodiment, the sentence that “the control channel candidate and the first control channel candidate have identical scrambling” comprises the following meaning: the first node in the present application assumes that the control channel candidate and the first control channel candidate have the same scrambling.

In one embodiment, the sentence that “the control channel candidate and the first control channel candidate have identical scrambling” comprises the following meaning: a first scrambling sequence is a scrambling sequence of a PDCCH carried by the first control channel candidate, while a second scrambling sequence is a scrambling sequence of a PDCCH carried by the control channel candidate, where an initial value of a generating register for the first scrambling sequence and an initial value of a generating register for the second scrambling sequence are the same.

In one embodiment, the sentence that “the control channel candidate and the first control channel candidate have identical scrambling” comprises the following meaning: a first scrambling sequence is a scrambling sequence of a PDCCH carried by the first control channel candidate, while a second scrambling sequence is a scrambling sequence of a PDCCH carried by the control channel candidate, where the first scrambling sequence and the second scrambling sequence are generated by a same Gold Sequence with the length of 31 using a same initial value of a Generator.

In one embodiment, the phrase that “one control channel candidate associated with the first control channel candidate” includes a meaning that a size of a format of DCI carried by the control channel candidate is identical to a size of a format of DCI carried by the first control channel candidate.

In one embodiment, the sentence that “a size of a format of DCI carried by the control channel candidate is identical to a size of a format of DCI carried by the first control channel candidate” comprises the following meaning: the first node in the present application assumes that the size of the format of DCI carried by the control channel candidate and the size of the format of DCI carried by the first control channel candidate are the same.

In one embodiment, the sentence that “a size of a format of DCI carried by the control channel candidate is identical to a size of a format of DCI carried by the first control channel candidate” comprises the following meaning: a size of a DCI Payload carried by the control channel candidate and a size of a DCI Payload carried by the first control channel candidate are the same.

In one embodiment, the sentence that “a size of a format of DCI carried by the control channel candidate is identical to a size of a format of DCI carried by the first control channel candidate” comprises the following meaning: a number of bits comprised in the format of DCI carried by the control channel candidate and a number of bits comprised in the format of DCI carried by the first control channel candidate are equal.

In one embodiment, the sentence that “a size of a format of DCI carried by the control channel candidate is identical to a size of a format of DCI carried by the first control channel candidate” comprises the following meaning: a number of bits comprised in a DCI Payload carried by the control channel candidate and a number of bits comprised in a DCI Payload carried by the first control channel candidate are equal.

In one embodiment, the phrase that “DCI carried by the first control channel candidate” comprises the following meaning: DCI that the first node in the present application assumes to be carried by the first control channel candidate.

In one embodiment, the phrase that “DCI carried by the first control channel candidate” comprises the following meaning: DCI that the first control channel candidate actually carries.

In one embodiment, the phrase that “DCI carried by the control channel candidate” comprises the following meaning: DCI that the first node in the present application assumes to be carried by the control channel candidate.

In one embodiment, the phrase that “DCI carried by the control channel candidate” comprises the following meaning: DCI that the control channel candidate actually carries.

In one embodiment, a Format of DCI carried by the first control channel candidate is one of 0_1, 0_2, 0_3, 1_0, 1_1, 1_2, or 1_3, while a format of DCI carried by the control channel candidate is one of 0_1, 0_2, 0_3, 1_0, 11, 1_2, or 13.

In one embodiment, a Format of DCI carried by the first control channel candidate is one of DCI Formats that can be supported.

In one embodiment, a Format of DCI carried by the first control channel candidate is one of DCI Formats that are supported by a UE-Specific Search Space Set (USS set).

In one embodiment, the phrase that “one control channel candidate associated with the first control channel candidate” includes a meaning that the control channel candidate and the first control channel candidate are associated with different control resource sets.

In one embodiment, the phrase that “one control channel candidate associated with the first control channel candidate” includes a meaning that there exist overlapping time-domain resources between time-domain resources indicated by DCI carried by the control channel candidate and time-domain resources indicated by DCI carried by the first control channel candidate.

In one embodiment, the phrase that “one control channel candidate associated with the first control channel candidate” includes a meaning that both time-domain resources indicated by DCI carried by the control channel candidate and time-domain resources indicated by DCI carried by the first control channel candidate comprise time-domain resources occupied by the first signal.

In one embodiment, the phrase that “one control channel candidate associated with the first control channel candidate” includes a meaning that DCI carried by the control channel candidate and DCI carried by the first control channel candidate are both used for scheduling the first signal.

In one embodiment, the phrase that “DCI carried by the control channel candidate and DCI carried by the first control channel candidate are both used for scheduling the first signal” comprises the following meaning: the first node in the present application assumes that DCI carried by the control channel candidate and DCI carried by the first control channel candidate are both used for scheduling the first signal.

In one embodiment, the phrase that “one control channel candidate associated with the first control channel candidate” includes a meaning that DCI carried by the first control channel candidate and DCI carried by the control channel candidate are used for scheduling the first signal.

In one embodiment, the phrase that “one control channel candidate associated with the first control channel candidate” includes a meaning that the first node in the present application assumes that DCI carried by the control channel candidate and DCI carried by the first control channel candidate are used for scheduling the first signal.

In one embodiment, the phrase that “one control channel candidate associated with the first control channel candidate” includes a meaning that DCI carried by the first control channel candidate and DCI carried by the control channel candidate are used for scheduling a same Transport Block (TB).

In one embodiment, the phrase that “one control channel candidate associated with the first control channel candidate” includes a meaning that the first node in the present application assumes that DCI carried by the first control channel candidate and DCI carried by the control channel candidate are used for scheduling a same Transport Block (TB).

In one embodiment, the phrase that “one control channel candidate associated with the first control channel candidate” includes a meaning that DCI carried by the first control channel candidate and DCI carried by the control channel candidate are two repetitions of a same DCI.

In one embodiment, the phrase that “one control channel candidate associated with the first control channel candidate” includes a meaning that the first node assumes that DCI carried by the first control channel candidate and DCI carried by the control channel candidate are two repetitions of a same DCI.

In one embodiment, the phrase that “one control channel candidate associated with the first control channel candidate” includes a meaning that DCI carried by the first control channel candidate and DCI carried by the control channel candidate are two pieces of independent scheduling information of a same Transport Block (TB).

In one embodiment, the phrase that “one control channel candidate associated with the first control channel candidate” comprises the following meaning: DCI carried by the first control channel candidate and DCI carried by the control channel candidate are two transmissions in Multi-Chance transmissions of scheduling information of a same Transport Block (TB).

In one embodiment, the phrase that “one control channel candidate associated with the first control channel candidate” comprises the following meaning: the first node assumes that DCI carried by the first control channel candidate and DCI carried by the control channel candidate are two transmissions in Multi-Chance transmissions of scheduling information of a same Transport Block (TB).

In one embodiment, the phrase that “one control channel candidate associated with the first control channel candidate” comprises the following meaning: an index of the first control channel candidate is associated with an index of the control channel candidate.

In one embodiment, the phrase that “one control channel candidate associated with the first control channel candidate” comprises the following meaning: there is a mapping relationship between an index of the first control channel candidate and an index of the control channel candidate.

In one embodiment, the phrase that “one control channel candidate associated with the first control channel candidate” comprises the following meaning: there is a function-based relationship between an index of the first control channel candidate and an index of the control channel candidate.

In one embodiment, the phrase that “one control channel candidate associated with the first control channel candidate” comprises the following meaning: CCEs occupied by the first control channel candidate are associated with CCEs occupied by the control channel candidate.

### Embodiment 6

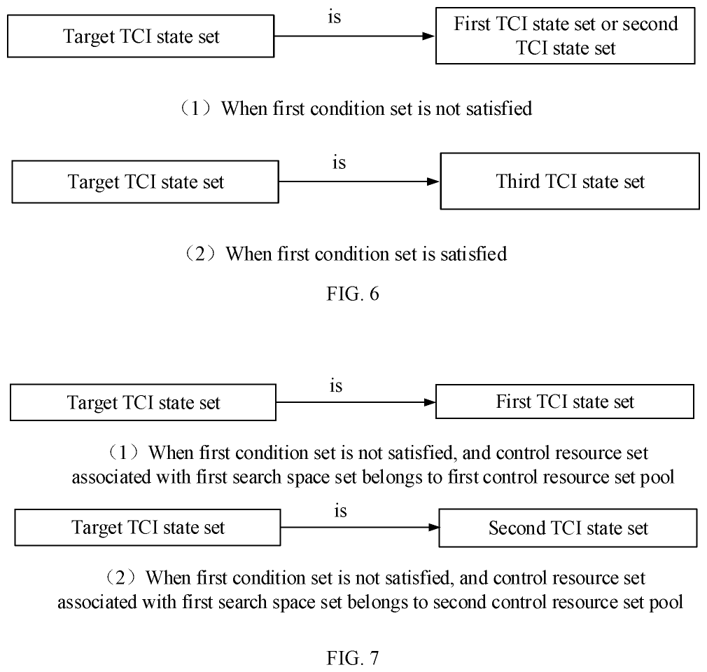

Embodiment 6 illustrates a schematic diagram of a target TCI state set, as shown in FIG. 6.

In Embodiment 6, when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

In one embodiment, the first control channel candidate belongs to the first control resource set pool or the second control resource set pool.

In one embodiment, a control resource set associated with the first search space set belongs to the first control resource set pool or the second control resource set pool.

In one embodiment, when the first condition set is not satisfied, a control resource set associated with the first search space set is used to determine whether the target TCI state set is a first TCI state set or a second TCI state set.

In one embodiment, when the first condition set is not satisfied, which one of the first control resource set pool and the second control resource set pool the first search space set is related to is used to determine whether the target TCI state set is a first TCI state set or a second TCI state set.

In one embodiment, when the first condition set is not satisfied, whether a control resource set associated with the first search space set belongs to the first control resource set pool or the second control resource set pool is used to determine whether the target TCI state set is a first TCI state set or a second TCI state set.

In one embodiment, the phrase that “a control resource set associated with a search space set” includes a meaning that: any control channel candidate in a search space set consists of at least one CCE in a control resource set associated with the search space set.

In one embodiment, the phrase that “a control resource set associated with a search space set” includes a meaning that: a control resource set associated with a search space set is used to determine time-frequency resources occupied by the search space set in a Monitoring Occasion.

In one embodiment, the phrase that “a control resource set associated with a search space set” includes a meaning that: a number of Resource Elements (REs) occupied by a search space set in a Monitoring Occasion is a number of REs occupied by a control resource set associated with the search space set.

In one embodiment, the phrase that “a control resource set associated with a search space set” includes a meaning that: a number of Resource Blocks (RBs) occupied by a search space set in frequency domain is a number of RBs occupied by a control resource set associated with the search space set in frequency domain.

In one embodiment, the phrase that “a control resource set associated with a search space set” includes a meaning that: frequency-domain resources occupied by a search space set are frequency-domain resources occupied by a control resource set associated with the search space set.

In one embodiment, the phrase that “a control resource set associated with a search space set” includes a meaning that: a number of symbols occupied by a control resource set associated with a search space set is used to determine a number of symbols occupied by the search space set in a Monitoring Occasion.

In one embodiment, the phrase that “a control resource set associated with a search space set” includes a meaning that: a number of symbols occupied by a search space set in a Monitoring Occasion is a number of symbols occupied by a control resource set associated with the search space set.

In one embodiment, the phrase that “a control resource set associated with a search space set” includes a meaning that: configuration information of a search space set comprises an index of a control resource set associated with the search space set.

In one embodiment, a said Monitoring Occasion comprises a time duration.

In one embodiment, a said Monitoring Occasion comprises at least one symbol.

In one embodiment, a said Monitoring Occasion comprises a slot.

In one embodiment, a said Monitoring Occasion comprises a sub-slot.

In one embodiment, a said Monitoring Occasion comprises a subframe.

In one embodiment, the first TCI state set and the second TCI state set are respectively indicated by two MAC CEs.

In one embodiment, the first TCI state set comprises at least one TCI state.

In one embodiment, the first TCI state set comprises multiple TCI states.

In one embodiment, the first TCI state set comprises at least one TCI state subset.

In one embodiment, the second TCI state set comprises at least one TCI state.

In one embodiment, the second TCI state set comprises multiple TCI states.

In one embodiment, the second TCI state set comprises at least one TCI state subset.

In one embodiment, the third TCI state set comprises at least one TCI state.

In one embodiment, the third TCI state set comprises multiple TCI states.

In one embodiment, the third TCI state set comprises at least one TCI state subset.

In one embodiment, at least one TCI state subset in the third TCI state set comprises more than one TCI state.

In one embodiment, any TCI state subset in the third TCI state set comprises more than one TCI state.

In one embodiment, any TCI state subset in the first TCI state set comprises only one TCI state.

In one embodiment, any TCI state subset in the second TCI state set comprises only one TCI state.

In one embodiment, at least one TCI state subset in the first TCI state set comprises only one TCI state.

In one embodiment, at least one TCI state subset in the second TCI state set comprises only one TCI state.

In one embodiment, a TCI state subset comprises at least one TCI state.

In one embodiment, a TCI state subset comprises one or two TCI states.

In one embodiment, the third TCI state set and the first TCI state set are respectively indicated by different MAC CEs.

In one embodiment, the third TCI state set, the first TCI state set and the second TCI state set are respectively indicated by three MAC CEs.

In one embodiment, the first TCI state set and the second TCI state set are respectively indicated by two MAC CEs with a same name.

In one embodiment, the third TCI state set and the first TCI state set are respectively indicated by two MAC CEs with different names.

In one embodiment, the first TCI state set and the second TCI state set are respectively indicated by two MAC CEs of a same type.

In one embodiment, the third TCI state set and the first TCI state set are respectively indicated by two MAC CEs of different types.

In one embodiment, two MAC CEs of a same type comprise a same field, while two MAC CEs of different types comprise at least one field different from each other.

In one embodiment, two MAC CEs of a same type have identical functions, while two MAC CEs of different types have different functions.

In one embodiment, two MAC CEs of a same type are for identical application scenarios, while two MAC CEs of different types are for different application scenarios.

In one embodiment, the third TCI state set is configured independently of the first TCI state set or the second TCI state set.

In one embodiment, the third TCI state set is configured independently of the first TCI state set and the second TCI state set.

In one embodiment, the first TCI state set and the second TCI state set are used to determine the third TCI state set.

In one embodiment, the third TCI state set is the intersection of the first TCI state set and the second TCI state set.

In one embodiment, at least one TCI state in the third TCI state set belongs to the first TCI state set, and at least one TCI state in the third TCI state set belongs to the second TCI state set.

In one embodiment, the first control resource set pool and the second control resource set pool both belong to a first bandwidth part (BWP), where the third TCI state set is common to all control resource sets in the first BWP.

In one embodiment, the phrase that “the third TCI state set is common to all control resource sets in the first BWP” includes a meaning that: the third TCI state set is applied in all control resource sets in the first BWP.

In one embodiment, the phrase that “the third TCI state set is common to all control resource sets in the first BWP” includes a meaning that: the third TCI state set is used for a PDSCH scheduled by a control signaling in any control resource set in the first BWP.

In one embodiment, the phrase that “the third TCI state set is common to all control resource sets in the first BWP” includes a meaning that: a TCI state of a PDSCH scheduled by any control signaling in any control resource set in the first BWP belongs to the third TCI state set.

In one embodiment, the first control resource set pool comprises at least one control resource set, while the second control resource set pool comprises at least one control resource set.

In one embodiment, the first control resource set pool and the second control resource set pool respectively consist of control resource set(s) with different values of CORESETPoolIndex.

In one embodiment, the first control resource set pool consists of control resource set(s) for which a parameter CORESETPoolIndex configured has a value of 0, while the second control resource set pool consists of control resource set(s) for which a parameter CORESETPoolIndex configured has a value of 1.

In one embodiment, the first control resource set pool consists of control resource set(s) for which a parameter CORESETPoolIndex configured has a value of 1, while the second control resource set pool consists of control resource set(s) for which a parameter CORESETPoolIndex configured has a value of 0.

In one embodiment, the first control resource set pool consists of control resource set(s) for which a parameter CORESETPoolIndex configured has a value of 0 and control resource set(s) not configured with the parameter CORESETPoolIndex, while the second control resource set pool consists of control resource set(s) for which a parameter CORESETPoolIndex configured has a value of 1.

In one embodiment, the first control resource set pool consists of control resource set(s) for which a parameter CORESETPoolIndex configured has a value of 1, while the second control resource set pool consists of control resource set(s) for which a parameter CORESETPoolIndex configured has a value of 0 and control resource set(s) not configured with the parameter CORESETPoolIndex.

In one embodiment, a said control resource set occupies at least one symbol in time domain, and occupies at least one Resource Block (RB) in frequency domain

In one embodiment, a said control resource set comprises multiple REs.

In one embodiment, a said control resource set comprises at least one CCE.

In one embodiment, a said control resource set is a Control Resource Set (CORESET).

In one embodiment, an index of a said control resource set is configured by a parameter controlResource SetId.

In one embodiment, a said control resource set is configured by an IE ControlResourceSet of an RRC signaling

In one embodiment, the specific definition of the CORESET can be found in 3GPP TS 38.213, Section 10.

In one embodiment, the specific definition of the IE ControlResourceSet can be found in 3GPP TS 38.331, Section 6.3.2.

In one embodiment, the symbol is a single-carrier symbol.

In one embodiment, the symbol is a multi-carrier symbol.

In one embodiment, the multicarrier symbol is an Orthogonal Frequency Division Multiplexing (OFDM) Symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multi Carrier (FBMC) symbol.

In one embodiment, the multicarrier symbol comprises a Cyclic Prefix (CP).

In one embodiment, the phrase that “the first TCI state set is specific to a first control resource set pool” includes a meaning that: the first TCI state set is configured for a first control resource set pool; the phrase that “the second TCI state set is specific to a second control resource set pool” includes a meaning that: the second TCI state set is configured for a second control resource set pool.

In one embodiment, the phrase that “the first TCI state set is specific to a first control resource set pool” includes a meaning that: the first TCI state set is only applied to a first control resource set pool; the phrase that “the second TCI state set is specific to a second control resource set pool” includes a meaning that: the second TCI state set is only applied to a second control resource set pool.

In one embodiment, the phrase that “the first TCI state set is specific to a first control resource set pool” includes a meaning that: the first TCI state set is not applied to any control resource set out of a first control resource set pool; the phrase that “the second TCI state set is specific to a second control resource set pool” includes a meaning that: the second TCI state set is not applied to any control resource set out of a second control resource set pool.

In one embodiment, the phrase that “the first TCI state set is specific to a first control resource set pool” includes a meaning that: the first TCI state set is only used for a PDSCH scheduled by a control signaling in a first control resource set pool; the phrase that “the second TCI state set is specific to a second control resource set pool” includes a meaning that: the second TCI state set is only used for a PDSCH scheduled by a control signaling in a second control resource set pool.

In one embodiment, the phrase that “the first TCI state set is specific to a first control resource set pool” includes a meaning that: a TCI state of a PDSCH scheduled by any control signaling in a first control resource set pool belongs to the first TCI state set; the phrase that “the second TCI state set is specific to a second control resource set pool” includes a meaning that: a TCI state of a PDSCH scheduled by any control signaling in a second control resource set pool belongs to the second TCI state set.

### Embodiment 7

Embodiment 7 illustrates another schematic diagram of a target TCI state set, as shown in FIG. 7.

In Embodiment 7, the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set.

### Embodiment 8

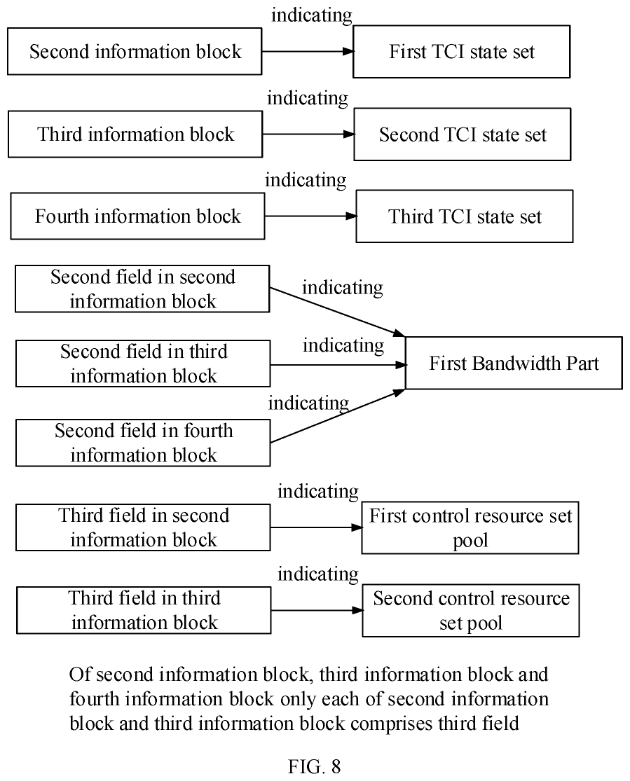

Embodiment 8 illustrates a schematic diagram of a second information block, a third information block and a fourth information block, as shown in FIG. 8.

In Embodiment 8, the second information block indicates the first TCI state set, the third information block indicates the second TCI state set, while the fourth information block indicates the third TCI state set; each of the second information block, the third information block and the fourth information block comprises a second field, the second field indicating a bandwidth part (BWP), where the second field in the second information block, the second field in the third information block and the second field in the fourth information block all indicate a first bandwidth part (BWP); each of the S search space sets belongs to the first bandwidth part (BWP); among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

In one embodiment, the second information block indicates an index of each TCI state in the first TCI state set; the third information block indicates an index of each TCI state in the second TCI state set; the fourth information block indicates an index of each TCI state in the third TCI state set.

In one embodiment, a name of the second information block includes TCI States Activation/Deactivation.

In one embodiment, a name of the second information block includes TCI States Activation/Deactivation for UE-specific PDSCH MAC CE.

In one embodiment, a name of the third information block includes TCI States Activation/Deactivation.

In one embodiment, a name of the third information block includes TCI States Activation/Deactivation for UE-specific PDSCH MAC CE.

In one embodiment, a name of the fourth information block includes TCI States Activation/Deactivation.

In one embodiment, a name of the fourth information block includes TCI States Activation/Deactivation for UE-specific PDSCH MAC CE.

In one embodiment, the second information block and the fourth information block are different MAC CEs.

In one embodiment, the second information block, the third information block and the fourth information block are three MAC CEs.

In one embodiment, the second information block and the third information block are two MAC CEs with a same name.

In one embodiment, the second information block and the fourth information block are two MAC CEs with different names.

In one embodiment, the second information block and the third information block are two MAC CEs of a same type.

In one embodiment, the second information block and the fourth information block are two MAC CEs of different types.

In one embodiment, the second information block is TCI States Activation/Deactivation for UE-specific PDSCH MAC CE.

In one embodiment, the third information block is TCI States Activation/Deactivation for UE-specific PDSCH MAC CE.

In one embodiment, the fourth information block is Enhanced TCI States Activation/Deactivation for UE-specific PDSCH MAC CE.

In one embodiment, the specific definition of the TCI States Activation/Deactivation for UE-specific PDSCH MAC CE can be found in 3GPP TS38.321, Section 6.1.3.

In one embodiment, the specific definition of the Enhanced TCI States Activation/Deactivation for UE-specific PDSCH MAC CE can be found in 3GPP TS38.321, Section 6.1.3.

In one embodiment, the second field comprises at least one bit.

In one embodiment, the second field comprises 2 bits.

In one embodiment, the second field is a BWP ID field.

In one embodiment, for the specific definition of the BWP ID field, refer to 3GPP TS38.321, Section 6.1.3.

In one embodiment, the first bandwidth part is a BWP.

In one embodiment, the phrase that “each of the S search space sets belongs to the first bandwidth part (BWP)” includes a meaning that: each of the S search space sets belongs to the first bandwidth part (BWP) in frequency domain

In one embodiment, the phrase that “each of the S search space sets belongs to the first bandwidth part (BWP)” includes a meaning that: each of the S search space sets is configured for the first bandwidth part (BWP).

In one embodiment, the third field comprises at least one bit.

In one embodiment, the third field comprises one bit.

In one embodiment, the third field comprises more than one bit.

In one embodiment, the third field is a CORESET Pool ID field.

In one embodiment, for the specific definition of the CORESET Pool ID field, refer to 3GPP TS38.321, Section 6.1.3.

In one embodiment, the fourth information block does not comprise a third field.

In one embodiment, a control resource set pool comprises at least one control resource set.

In one embodiment, the third field in the second information block indicates an index of the first control resource set pool, while the third field in the third information block indicates an index of the second control resource set pool.

In one embodiment, a value of the third field in the second information block is different from a value of the third field in the third information block.

In one embodiment, one of a value of the third field in the second information block and a value of the third field in the third information block is 0 and the other is 1.

### Embodiment 9

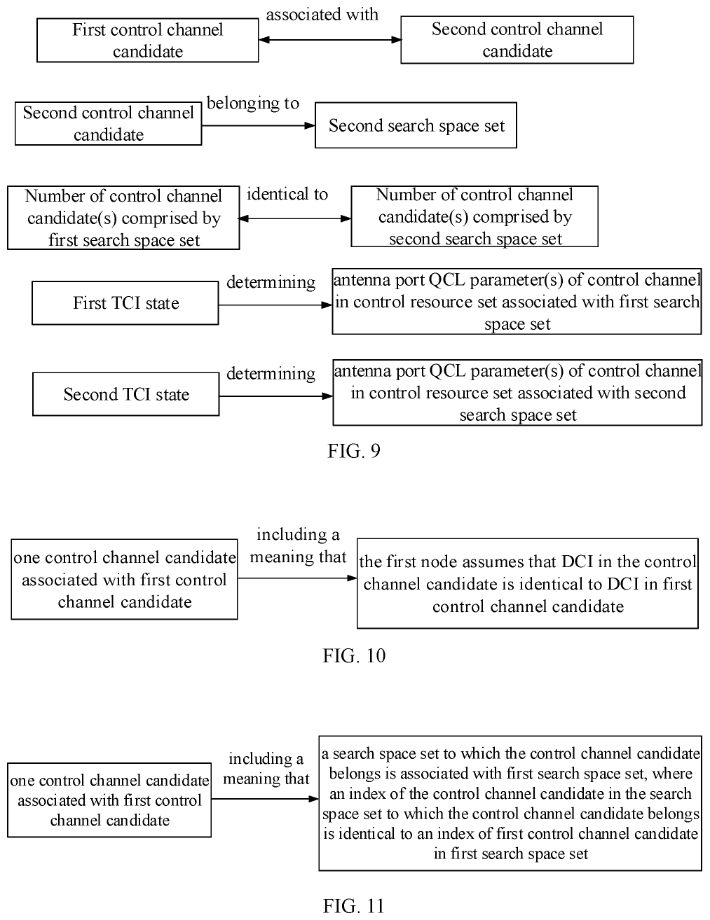

Embodiment 9 illustrates a schematic diagram illustrating a control channel candidate associated with the first control channel candidate, as shown in FIG. 9.

In Embodiment 9, the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

In one embodiment, the second Search Space Set comprises at least one control channel candidate.

In one embodiment, the second Search Space Set comprises multiple REs.

In one embodiment, the second control channel candidate is a Physical Downlink Control Channel (PDCCH) Candidate.

In one embodiment, the second control channel candidate is a monitored Physical Downlink Control Channel Candidate (Monitored PDCCH Candidate).

In one embodiment, the second control channel candidate occupies multiple REs.

In one embodiment, the second control channel candidate occupies one or more CCEs.

In one embodiment, a number of CCE(s) occupied by the second control channel candidate is equal to one of 1, 2, 4, 8 or 16.

In one embodiment, the first control channel candidate and the second control channel candidate respectively occupy different CCEs.

In one embodiment, a QCL parameter of the first control channel candidate is different from a QCL parameter of the second control channel candidate.

In one embodiment, the first TCI state is a TCI state of the first control channel candidate, while the second TCI state is a TCI state of the second control channel candidate.

In one embodiment, a first TCI state is used to determine an antenna port QCL parameter of the first control channel candidate, while a second TCI state is used to determine an antenna port QCL parameter of the second control channel candidate.

In one embodiment, a first TCI state is used to determine an antenna port QCL parameter of a PDCCH DMRS on the first control channel candidate, while a second TCI state is used to determine an antenna port QCL parameter of a PDCCH DMRS on the second control channel candidate.

In one embodiment, a first TCI state is used for monitoring the first control channel candidate, while a second TCI state is used for monitoring the second control channel candidate.

In one embodiment, a first TCI state is used for monitoring a PDCCH DMRS on the first control channel candidate, while a second TCI state is used for monitoring a PDCCH DMRS on the second control channel candidate.

In one embodiment, a first TCI state is used for monitoring the first search space set, while a second TCI state is used for monitoring the second search space set.

In one embodiment, a first TCI state is used for monitoring a control resource set associated with the first search space set, while a second TCI state is used for monitoring a control resource set associated with the second search space set.

In one embodiment, a type of the QCL parameter includes QCL-TypeD.

In one embodiment, for the specific definition of the QCL-TypeD, refer to 3GPP TS38.214, Section 5.1.5.

In one embodiment, the QCL parameter comprises a Spatial Rx parameter.

In one embodiment, the QCL parameter comprises a spatial domain filter.

In one embodiment, the aggregation level is a CCE Aggregation Level (AL).

In one embodiment, the Aggregation Level (AL) includes at least one of 1, 2, 4, 8 or 16.

In one embodiment, the specific definition of the aggregation level can be found in 3GPP TS 38.213, Section 10.

In one embodiment, the sentence that “a given TCI state is used to determine antenna port Quasi Co-Location (QCL) information of control channel(s) in a control resource set associated with a given search space set” includes a meaning that: the first node assumes that a transmission antenna port of control channel(s) in a control resource set associated with the given search space set is Quasi Co-Located (QCL) with one or more reference signals indicated by a given TCI state.

In one embodiment, the sentence that “a given TCI state is used to determine antenna port Quasi Co-Location (QCL) information of control channel(s) in a control resource set associated with a given search space set” includes a meaning that: the first node assumes that a DMRS antenna port associated with reception of control channel(s) in a control resource set associated with the given search space set is QCL with one or more reference signals indicated by a given TCI state.

In one embodiment, the sentence that “a given TCI state is used to determine antenna port Quasi Co-Location (QCL) information of control channel(s) in a control resource set associated with a given search space set” includes a meaning that: the first node receives a reference signal indicated by a given TCI state and monitors control channel(s) in a control resource set associated with the given search space set using a same QCL parameter.

In one embodiment, the sentence that “a given TCI state is used to determine antenna port Quasi Co-Location (QCL) information of control channel(s) in a control resource set associated with a given search space set” includes a meaning that: the first node receives a reference signal indicated by a given TCI state and monitors control channel(s) in a control resource set associated with the given search space set using a same spatial domain filter.

In one embodiment, the sentence that “a given TCI state is used to determine antenna port Quasi Co-Location (QCL) information of control channel(s) in a control resource set associated with a given search space set” includes a meaning that: the first node transmits a reference signal indicated by a given TCI state and monitors control channel(s) in a control resource set associated with the given search space set using a same QCL parameter.

In one embodiment, the sentence that “a given TCI state is used to determine antenna port Quasi Co-Location (QCL) information of control channel(s) in a control resource set associated with a given search space set” includes a meaning that: the first node transmits a reference signal indicated by a given TCI state and monitors control channel(s) in a control resource set associated with the given search space set using a same spatial domain filter.

In one embodiment, the given TCI state is the first TCI state in the present application, and the given search space set is the first search space set in the present application.

In one embodiment, the given TCI state is the second TCI state in the present application, and the given search space set is the second search space set in the present application.

### Embodiment 10

Embodiment 10 illustrates another schematic diagram illustrating a control channel candidate associated with the first control channel candidate, as shown in FIG. 10.

In Embodiment 10, the phrase that “one control channel candidate associated with the first control channel candidate” includes a meaning that the first node assumes that a DCI in the control channel candidate is identical to a DCI in the first control channel candidate. the control channel candidate is any control channel candidate in any search space set among the S search space sets different from the first search space set; or, the control channel candidate is the second control channel candidate.

In one embodiment, the phrase that “one control channel candidate not associated with the first control channel candidate” includes a meaning that the first node cannot assume that a DCI in the control channel candidate is identical to a DCI in the first control channel candidate.

### Embodiment 11

Embodiment 11 illustrates another schematic diagram illustrating a control channel candidate associated with the first control channel candidate, as shown in FIG. 11.

In Embodiment 11, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set. the control channel candidate is any control channel candidate in any search space set among the S search space sets different from the first search space set; or, the control channel candidate is the second control channel candidate.

In one embodiment, the phrase that “one control channel candidate not associated with the first control channel candidate” includes a meaning that a search space set to which the control channel candidate belongs is associated with the first search space set, where an index of the control channel candidate in a search space set to which the control channel candidate belongs is different from an index of the first control channel candidate in the first search space set.

In one embodiment, the phrase that “one control channel candidate not associated with the first control channel candidate” includes a meaning that a search space set to which the control channel candidate belongs is not associated with the first search space set.

In one embodiment, an index of the control channel candidate in a search space set to which the control channel candidate belongs is an index of the control channel candidate among all control channel candidates comprised by the search space set to which the control channel candidate belongs.

In one embodiment, an index of the control channel candidate in a search space set to which the control channel candidate belongs is an index of the control channel candidate among all control channel candidates for an aggregation level (AL) of the control channel candidate comprised by the search space set to which the control channel candidate belongs.

In one embodiment, an index of the first control channel candidate in the first search space set is an index of the first control channel candidate among all control channel candidates comprised by the first search space set.

In one embodiment, an index of the first control channel candidate in the first search space set is an index of the first control channel candidate among all control channel candidates for an AL of the first control channel candidate comprised by the first search space set.

In one embodiment, the phrase that “a search space set to which the control channel candidate belongs is associated with the first search space set” includes a meaning that for each AL, a number of control channel candidate(s) comprised by the search space set to which the control channel candidate belongs is identical to a number of control channel candidate(s) comprised by the first search space set.

In one embodiment, the phrase that “a search space set to which the control channel candidate belongs is not associated with the first search space set” includes a meaning that there exists at least one AL for which a number of control channel candidate(s) comprised by the search space set to which the control channel candidate belongs is different from a number of control channel candidate(s) comprised by the first search space set

In one embodiment, the phrase that “a search space set to which the control channel candidate belongs is associated with the first search space set” includes a meaning that configuration information of the first search space set comprises an index of the search space set to which the control channel candidate belongs.

In one embodiment, the phrase that “a search space set to which the control channel candidate belongs is not associated with the first search space set” includes a meaning that configuration information of the first search space set does not comprise an index of the search space set to which the control channel candidate belongs.

In one embodiment, the phrase that “a search space set to which the control channel candidate belongs is associated with the first search space set” includes a meaning that higher layer parameter(s) indicates/indicate that a search space set to which the control channel candidate belongs is associated with the first search space set.

In one embodiment, the phrase that “a search space set to which the control channel candidate belongs is not associated with the first search space set” includes a meaning that there exists no higher layer parameter indicating that a search space set to which the control channel candidate belongs is associated with the first search space set.

### Embodiment 12

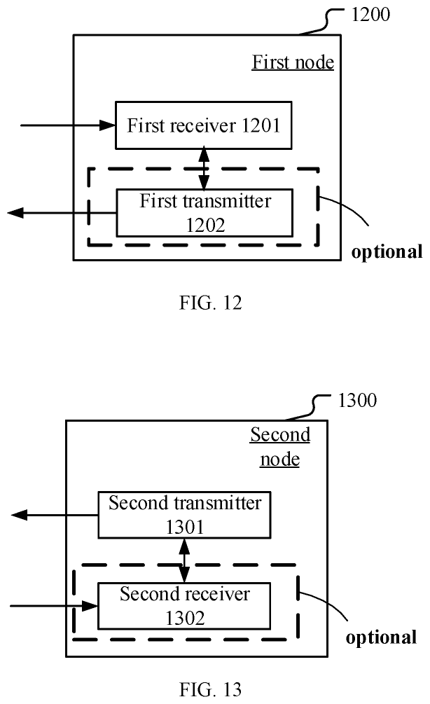

Embodiment 12 illustrates a structure block diagram of a processing device in a first node, as shown in FIG. 12. In FIG. 12, a processing device 1200 in a first node comprises a first receiver 1201. Optionally, the processing device 1200 in the first node also comprises a first transmitter 1202.

In one embodiment, the first node 1200 is a UE.

In one embodiment, the first node 1200 is a relay node.

In one embodiment, the first node 1200 is vehicle-mounted communication equipment.

In one embodiment, the first node 1200 is a UE supporting V2X communications.

In one embodiment, the first node 1200 is a relay node supporting V2X communications.

In one embodiment, the first receiver 1201 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1202 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first three of the antenna 452, the transmitter 454, the multi-antenna transmitting processor 457, the transmitting processor 468, the controller/processor 459 the memory 460 and the data source 467 in FIG. 4 of the present application.

In one embodiment, the first transmitter 1202 comprises at least the first two of the antenna 452, the transmitter 454, the multi-antenna transmitting processor 457, the transmitting processor 468, the controller/processor 459, the memory 460 and the data source 467 in FIG. 4 of the present application.

The first receiver 1201 receives a first information block; and receives a first signaling; and receives a first signal.

In Embodiment 12, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one embodiment, when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

In one embodiment, the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set.

In one embodiment, the first receiver 1201 receives a second information block, receives a third information block and receives a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; each of the S search space sets belongs to the first bandwidth part; among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

In one embodiment, the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

In one embodiment, the phrase that “one control channel candidate associated with the first control channel candidate” includes a meaning that the first node assumes that a Downlink Control Information (DCI) in the control channel candidate is identical to a DCI in the first control channel candidate.

In one embodiment, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

In one embodiment, the processing device 1200 in the first node comprises:

the first transmitter 1202, transmitting a target information block;

herein, the target information block is used to indicate whether the first signal is correctly received.

### Embodiment 13

Embodiment 13 illustrates a structure block diagram a processing device in a second node according to one embodiment of the present application, as shown in FIG. 13. In FIG. 13, a processing device 1300 in a second node comprises a second transmitter 1301. Optionally, the processing device 1300 in the second node also comprises a second receiver 1302.

In one embodiment, the second node 1300 is a UE.

In one embodiment, the second node 1300 is a base station.

In one embodiment, the second node 1300 is a relay node.

In one embodiment, the second transmitter 1301 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first two of the antenna 420, the receiver 418, the multi-antenna receiving processor 472, the receiving processor 470, the controller/processor 475 and the memory 476 in FIG. 4 of the present application.

The second transmitter 1301 transmits a first information block; and transmits a first signaling; transmits a first signal.

In Embodiment 13, the first information block is used for indicating S search space sets, S being a positive integer greater than 1; the first signaling comprises a first field, the first field in the first signaling indicating a TCI state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

In one embodiment, when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

In one embodiment, the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set.

In one embodiment, the second transmitter 1301 transmits a second information block, transmits a third information block and transmits a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; each of the S search space sets belongs to the first bandwidth part; among the second information block, the third information block and the fourth information block only the second information block and the third information block each comprise a third field, the third field indicating a control resource set pool; the third field in the second information block indicates the first control resource set pool, while the third field in the third information block indicates the second control resource set pool.

In one embodiment, the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

In one embodiment, the phrase that “one control channel candidate associated with the first control channel candidate” includes a meaning that a receiver of the first signaling assumes that a DCI in the control channel candidate is identical to a DCI in the first control channel candidate.

In one embodiment, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

In one embodiment, the processing device 1300 in the second node comprises:

the second receiver 1302, receiving a target information block;

herein, the target information block is used to indicate whether the first signal is correctly received.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), GNSS, relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block; receiving a first signaling; and receiving a first signal;
wherein the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

2. The first node according to claim 1, characterized in that when the first condition set is not satisfied, the target TCI state set is a first TCI state set or a second TCI state set; when the first condition set is satisfied, the target TCI state set is a third TCI state set; the first TCI state set is specific to a first control resource set pool, while the second TCI state set is specific to a second control resource set pool.

3. The first node according to claim 2, characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set;
or, the first receiver receives a second information block, receives a third information block and receives a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; the S search space sets belong to the first bandwidth part; among the second information block, the third information block and the fourth information block only each of the second information block and the third information block comprises a third field, the third field indicating a control resource set pool; the third field in the second information block indicates the first control resource set pool, while the third field in the third information block indicates the second control resource set pool.

4. The first node according to claim 1, characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

5. The first node according to claim 1, characterized in that the phrase that “one control channel candidate associated with the first control channel candidate” includes a meaning that the first node assumes that a Downlink Control Information (DCI) in the control channel candidate is identical to a DCI in the first control channel candidate;
or, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

6. A second node for wireless communications, comprising:
a second transmitter, transmitting a first information block; transmitting a first signaling; and transmitting a first signal;
wherein the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

7. The second node according to claim 6, characterized in that when the first condition set is not satisfied, the target TCI state set is a first TCI state set or a second TCI state set; when the first condition set is satisfied, the target TCI state set is a third TCI state set; the first TCI state set is specific to a first control resource set, while the second TCI state set is specific to a second control resource set.

8. The second node according to claim 7, characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set;
or, the second transmitter transmits a second information block, receives a third information block and receives a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; the S search space sets belong to the first bandwidth part; among the second information block, the third information block and the fourth information block only each of the second information block and the third information block comprises a third field, the third field indicating a control resource set pool; the third field in the second information block indicates the first control resource set pool, while the third field in the third information block indicates the second control resource set pool.

9. The second node according to claim 6, characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

10. The second node according to claim 6, characterized in that the phrase that “one control channel candidate associated with the first control channel candidate” includes a meaning that a receiver of the first signaling assumes that a DCI in the control channel candidate is identical to a DCI in the first control channel candidate;
or, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

11. A method in a first node for wireless communications, comprising:
receiving a first information block; receiving a first signaling; and receiving a first signal;
wherein the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

12. The method according to claim 11, characterized in that when the first condition set is not satisfied, the target TCI state set is a first TCI state set or a second TCI state set; when the first condition set is satisfied, the target TCI state set is a third TCI state set; the first TCI state set is specific to a first control resource set, while the second TCI state set is specific to a second control resource set.

13. The method according to claim 12, characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set;
or, comprising: receiving a second information block, receiving a third information block and receiving a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; the S search space sets belong to the first bandwidth part; among the second information block, the third information block and the fourth information block only each of the second information block and the third information block comprises a third field, the third field indicating a control resource set pool; the third field in the second information block indicates the first control resource set pool, while the third field in the third information block indicates the second control resource set pool.

14. The method according to claim 11, characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

15. The method according to claim 11, characterized in that the phrase that “one control channel candidate associated with the first control channel candidate” includes a meaning that the first node assumes that a DCI in the control channel candidate is identical to a DCI in the first control channel candidate;
or, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.

16. A method in a second node for wireless communications, comprising:
transmitting a first information block; transmitting a first signaling; and transmitting a first signal;
wherein the first information block is used for indicating S search space sets, S being a positive integer greater than 1; the first signaling comprises a first field, the first field in the first signaling indicating a Transmission Configuration Indicator (TCI) state of the first signal in a target TCI state set; the first signaling occupies a first control channel candidate, the first control channel candidate belonging to a first search space set, the first search space set being one of the S search space sets; a first condition set comprises that there exists a search space set other than the first search space set among the S search space sets that comprises one control channel candidate associated with the first control channel candidate; whether the first condition set is satisfied is used to determine the target TCI state set; the target TCI state set comprises at least one TCI state; the first field comprises at least one bit.

17. The method according to claim 16, characterized in that when the first condition set is not satisfied, the target TCI state set is a first TCI state set or a second TCI state set; when the first condition set is satisfied, the target TCI state set is a third TCI state set; the first TCI state set is specific to a first control resource set, while the second TCI state set is specific to a second control resource set.

18. The method according to claim 17, characterized in that the first condition set is not satisfied; when a control resource set associated with the first search space set belongs to the first control resource set pool, the target TCI state set is the first TCI state set; when a control resource set associated with the first search space set belongs to the second control resource set pool, the target TCI state set is the second TCI state set;
or, comprising: transmitting a second information block, transmitting a third information block and transmitting a fourth information block; the second information block indicates the first TCI state set, the third information block indicates the second TCI state set, while the fourth information block indicates the third TCI state set; each of the second information block, the third information block and the fourth information block comprises a second field, the second field indicating a bandwidth part, where the second field in the second information block, the second field in the third information block and the second field in the fourth information block all indicate a first bandwidth part; the S search space sets belong to the first bandwidth part; among the second information block, the third information block and the fourth information block only each of the second information block and the third information block comprises a third field, the third field indicating a control resource set pool; the third field in the second information block indicates the first control resource set pool, while the third field in the third information block indicates the second control resource set pool.

19. The method according to claim 16, characterized in that the first control channel candidate is associated with a second control channel candidate, the second control channel candidate belonging to a second search space set, the second search space set being a search space set among the S search space sets other than the first search space set; for each aggregation level (AL), a number of control channel candidates comprised by the first search space set is identical to a number of control channel candidates comprised by the second search space set; a first TCI state is used to determine antenna port QCL parameter(s) of a control channel in a control resource set associated with the first search space set, while a second TCI state is used to determine antenna port QCL parameter(s) of a control channel in a control resource set associated with the second search space set.

20. The method according to claim 16, characterized in that the phrase that “one control channel candidate associated with the first control channel candidate” includes a meaning that a receiver of the first signaling assumes that a DCI in the control channel candidate is identical to a DCI in the first control channel candidate;
or, the phrase that “one control channel candidate associated with the first control channel candidate” includes a meaning that a search space set to which the control channel candidate belongs is associated with the first search space set, where an index of the control channel candidate in a search space set to which the control channel candidate belongs is identical to an index of the first control channel candidate in the first search space set.
